(19) United States
(12) Patent Application Publication
(10) Pub. No.: US 2006/0233192 A1
(43) Pub. Date: Oct. 19, 2006

(54) Display control method and information processing apparatus

(76) Inventor: Hidekazu Mihara, Kunitachi-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/390,566

(22) Filed: Mar. 28, 2006

(30) Foreign Application Priority Data
Mar. 30, 2005 (JP) 2005-097721

(51) Int. Cl. H04L 12/66; G06F 9/00

(52) U.S. Cl. 370/463; 715/781; 715/804; 715/764

(57) ABSTRACT

According to one embodiment, a display control method of software having a plurality of operation modes, the display control method includes switching a set operation mode to another operation mode, reading window location information associated with the another operation mode, from a plurality of window location information respectively prepared for the plurality of operation modes, and displaying a window on the display screen in accordance with the read window location information to switch the set operation mode.

### CROSS-REFERENCE TO RELATED APPLICATIONS

This application is based upon and claims the benefit of priority from Japanese Patent Application No. 2005-097721, filed Mar. 30, 2005, the entire contents of which are incorporated herein by reference.

### BACKGROUND

1. Field

One embodiment of the invention relates to a display control method and an image processing apparatus, which relocate a window or windows on a display screen.

2. Description of the Related Art

Operating systems for use in computers adopt a multi-window display method. In the multi-window display method, in order for a new window to be displayed on the screen, the sizes and positions of a window or windows displayed on the screen and the new window are calculated to produce relocation information, and the above window or windows are relocated and displayed along with the new window on the basis of the relocation information, as disclosed in Jpn. Pat. Appln. KOKAI Publication.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the configuration of a visual communication system in an embodiment of the present invention;

FIG. 2 is an exemplary block diagram roughly showing the structure of a client (computer) in the embodiment of the present invention;

FIG. 3 is an exemplary flowchart for use in explaining processing for determining the locations of windows at the time of starting performing of an application shared function of a VC client program and at the time of stopping thereof, in the embodiment of the present invention; and

FIG. 4 is an exemplary view showing an example of a window control based on the flowchart of FIG. 3.

### DETAILED DESCRIPTION

Various embodiments according to the invention will be described hereinafter with reference to the accompanying drawings. In general, according to one embodiment of the invention, a display control method of software having a plurality of operation modes, the display control method comprising: switching a set operation mode to another operation mode; reading window location information associated with the another operation mode, from a plurality of window location information respectively prepared for the plurality of operation modes; and displaying a window on the display screen in accordance with the read window location information to switch the set operation mode.

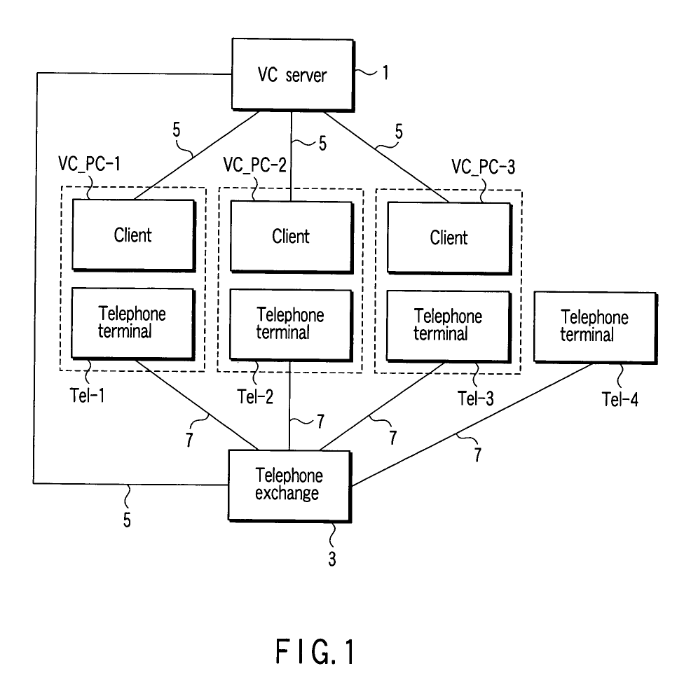

FIG. 1 is a view showing the configuration of a visual communication system according to an embodiment of the present invention.

In the embodiment, the visual communication system comprises a telephone exchange apparatus 3, at least one telephone terminal connected to the telephone exchange apparatus 3 by a telephone line 7, a visual communication server 1 (hereinafter referred to as VC server 1) which is connected to the telephone exchange apparatus 3 through an IP network such as a local area network 5 (hereinafter referred to as LAN 5), and which serves as a server computer, and at least one visual communication client (hereinafter referred to as client) connected to the VC server 1 through the LAN 5. In the case shown in FIG. 1, in the visual communication system, four telephone terminals, i.e., telephone terminals Tel-1 to Tel-4, are connected to the telephone exchange apparatus 3 by telephone lines 7, and three visual communication clients, i.e., visual communication clients VC_PC-1 to VC_PC-3 (hereinafter referred to as clients VC_PC-1 to VC_PC-3), are connected to the VC server 1 through the LAN 5.

In the case shown in FIG. 1, the telephone exchange apparatus 3 detects operations of the telephone terminals Tel-1 to Tel-4. To be more specific, the telephone exchange apparatus 3 detects the operations of the telephone terminals Tel-1 to Tel-4 through the telephone lines 7, and executes a line exchange procedure in accordance with the detected operations. For example, when a telephone terminal makes a call to another telephone terminal (i.e., it dials the telephone number thereof), the telephone exchange apparatus 3 enables those telephone terminals to communicate with each other, after detecting that they are in a state where they can communicate with each other.

Furthermore, for example, when the telephone terminal makes a call to another telephone terminal, the telephone exchange apparatus 3 also detects operations of those telephone terminals at a call issuing/receiving time. It should be noted that the operations of telephone terminals at the call issuing/receiving time correspond to the following operations: a telephone terminal, which dials the telephone number of another telephone terminal, issues a call in accordance with the dialed telephone number of the other telephone terminal; and the other telephone terminal rings to indicate reception of the call, etc. To be more specific, the above operations at the call issuing/receiving time correspond to issuance of a call by a telephone terminal, reception of the call by another telephone terminal, and disconnection of those telephone terminals from each other which is carried out to stop the communication between them.

The clients VC_PC-1 to VC_PC-3 are ordinary computers each comprising a central processing unit (CPU), a memory, a keyboard, a mouse, a hard disk device, a LAN interface (hereinafter referred to as LAN I/F), and a USB interface (hereinafter referred to as USB I/F).

In the hard disk device, a VCS client program is installed, and enables an image for video conference, which is provided to achieve a visual communication function, to be displayed; enables a picture (image) of a speaker, which is picked up by a camera, to be fetched as data, and be then send to the VC server 1; and enables contents of a window displayed on the display of a VC client (computer) to be sent as data.

In the memory, a client ID and client information are registered. The client ID is identification information regarding a VC client incorporating the above memory. The client information indicates the telephone number of the telephone terminal of the above VC client, and is referred to in association with the client ID.

The VCS client program has a communication function for causing the telephone terminal of the client to communicate with the VC server 1, and a log-in function for causing the client to log in on the VC server 1. The VCD client program achieve those functions in cooperation with the CPU and the memory.

In the above communication function, a signal regarding a session control is transmitted between the telephone terminal and the VC server 1, and the client information such as the client ID or telephone number associated therewith stored in the memory is transmitted between the telephone terminal and the VC server 1 in order that the VC client log in on the VC server 1.

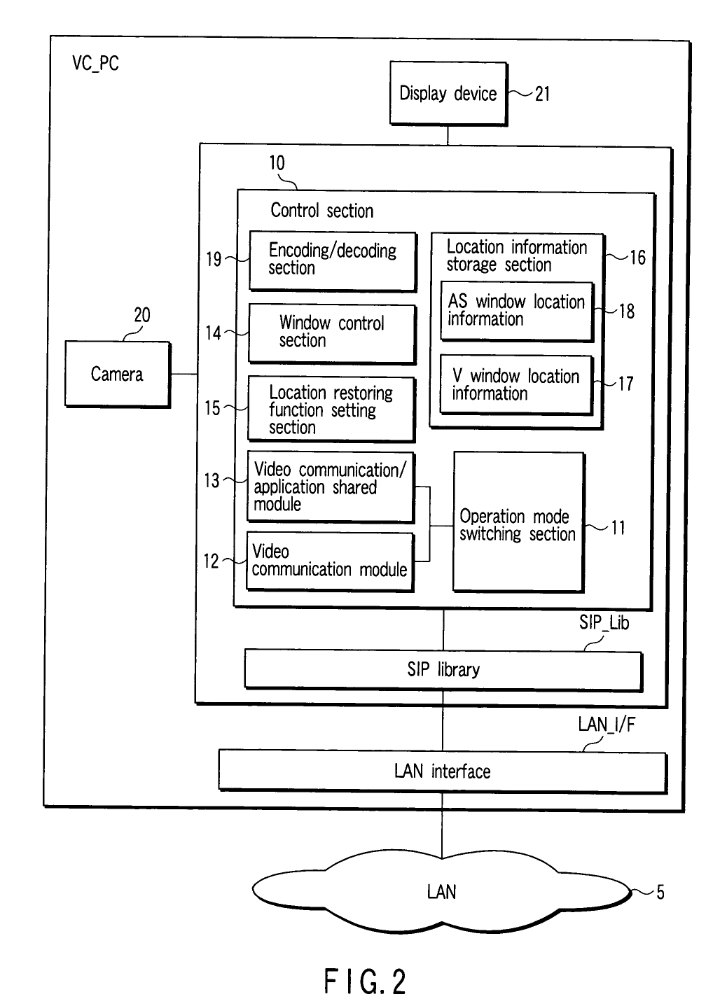

FIG. 2 is a block diagram roughly showing the structure of the VC client.

As shown in FIG. 2, the LAN_I/F is connected to the LAN 5, and a control section 5 is connected to the LAN_I/F.

A session initiation protocol (SIP) library SIP_Lib is provided in order to perform a communication operation such as a session control or registration of client information, at an application layer. Also, in order that a message of a SIP be transmitted between the VC client and the VC server 1, communication is carried out between the VC client and the VC server 1 by TCP/IP incorporated in an OS.

The control section 10 comprises an operation mode switching section 11, a video communication module 12, a video communication/application shared module 13, a window control section 14, a location restoring function setting section 15, a window location information storage section 16 and an encoding/decoding section 19. The window location information storage section 16 stores V window location information 17 and AS window location information 18. The V window location information 17 is information indicating the size and position of a window at the time of performing video communication, and the AS window location information 18 is information indicating the size and position of the window at the time of performing an application shared function.

A camera 20 is provided such that the bust of a person who is present in front of the VC client can be photographed. An image obtained by photographing the bust with the camera 20 is encoded by the encoding/decoding section 19, thereby producing image data. Image data transmitted from a VC client VC_PC on the party on the other end of the line is decoded by the encoding/decoding section 19, and is then displayed as an image by a display device 21. The function of the encoding/decoding section 19 may be performed by hardware, or it may be performed by executing software of the encoding/decoding section 19 with the CPU.

In the hard disk device, client software is installed, and enables an image for telephone conference to be displayed, and also a picture (image) of a speaker, which is obtained by the camera 20, to be fetched as image data, and be then transmitted to the VC server 1. The image for telephone conference enables a visual communication function to be performed.

The VC server 1 is a computer comprising a CPU, a memory, a display, a keyboard, a mouse, a hard disk device and a LAN interface (hereinafter referred to as LAN_I/F).

In the above hard disk device, an operating system (hereinafter referred to as OS) and a server software are installed. The OS, software such as the server software and the above hardware achieve the visual communication function in cooperation with each other.

In the above visual communication system, when two telephone terminals communicate with each other, the telephone exchange apparatus 3 informs the VC server 1 that they communicate with each other. The VC server 1 requests VC clients identified by the numbers of the above two telephone terminals to start a session. At this time, the VC server 1 informs each of the two VC clients of the IP address and port number of the other client. In order to perform video communication, each VC client issues a request for starting the video communication from the other VC client, i.e., the VC client whose IP address and port number are the same as the above IP address and port number of which the server 1 informs each VC client, and receives a request for starting the video communication from the other VC client, and further sends video data to the other VC client, and receives video data from the other VC client. For example, in the case shown in FIG. 1, when the telephone terminal Tel-4 communicates with one of the telephone terminals Tel-1 to Tel-3, since in the VC server 1, no VC client is registered as VC client identified by the number of the telephone terminal Tel-4, i.e., the telephone terminal Tel-4 is not incorporated in a VC client, a request for starting a session is not issued to the above one of the telephone terminals Tel-1 to Tel3, with which the telephone terminal Tel-4 communicates.

The visual communication system has the application shared function. The application shared function is a function of causing an application window such as a presentation application, which is displayed on the display of a VC client, to be also displayed on the display of another VC client. Furthermore, a pointer which is moved in accordance with the operation of the mouse is also displayed on the application window.

The VCS client program in the above embodiment restores a window location, i.e., the location of a window or windows, to that when the window or windows were used the last time, when the application shared function is performed or stopped.

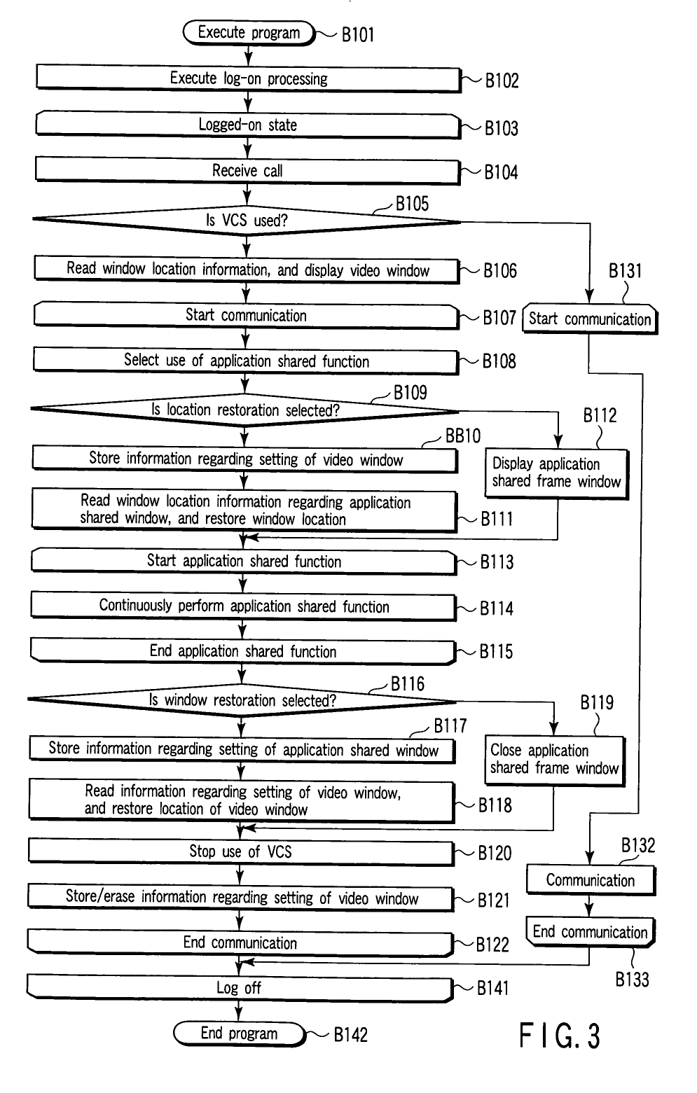

The window location when the application shared function starts to work and that when it is stopped will be explained with reference to FIG. 3. FIG. 3 is a flowchart for use in explaining processing for determining the window location at the time of starting the application shared function of the VC client program, and that at the time of stopping thereof.

When the VCS client program is executed (block B101), a log-on processing is performed on the VC server (block B102). After the log-on processing, when a call is made from a VC client to another VC client, it is received thereby(block B104). Then, it is checked whether the visual communication system (VCS) is used or not (block B105). When the visual communication system is not used, only regular voice communication is started (block B131), and the telephone terminals are made to disconnect from each other (block B132), thereby ending communication between them (block B133).

On the other hand, when the visual communication system is used, the operation mode switching section 11 selects the video communication module 12. The window control section 14 reads the V window location information 17 from the window location information storage section 16, and causes a video window to be displayed in accordance with the read V window location information 17 (block B106), and then video communication starts (block B107).

During the video communication, the user selects use of the application shared function (block B108). The operation mode switching section 11 selects the video communication/application shared module 13.

The window control section 14 reads data regarding setting, which is stored in the location restoring function setting section 15, and determines whether or not the setting is setting for restoring the window location (block B109). When the setting is the setting for restoring the window location, the window control section 14 updates the V window location information 17 stored in the window location information storage section 16 based on the present setting of the video window (block B110).

The window control section 14 reads the AS window location information 18 stored in the window location storage section, which indicates the display position and size of an application shared window. The window control section 14 updates the window location in accordance with the read AS window location information 18, and causes an application shared frame window (second window) to be displayed (block Bill). The location of the application shared frame window is automatically determined by the OS.

On the other hand, when the setting is not the setting for restoring the window location, the window control section 14 maintains the location of the video window, and causes the application shared frame window to be displayed (block B112).

When the application shared frame window is displayed (blocks B111 and B112), the application shared function is started (block B113), and is continuously performed (block B114).

While the application shared function is being performed, when an instruction for ending the application shared function is given, the operation mode switching section 11 selects the video communication module 12, thereby ending the application shared function (block B115).

The window control section 14 reads the data regarding the setting which is stored in the location restoring function setting section 15, and determines whether or not the setting is the setting for restoring the window location (block B116). When the setting is the setting for restoring the window location, the window control section 14 updates the AS window location information 18 stored in the window location information storage section 16 based on data (second window location information) regarding the setting of the location of the video window and that of the application shared frame window at the time of ending the application shred function (block B117). The window control section 14 reads the V window location information 17 stored in the window location information storage section 16, and restores the location of the video window based on the V window location information 17 (block B118).

On the other hand, when the setting is not the setting for restoring the window location, the window control section 14 closes the application shared frame window only (block B119).

Then, when the telephone terminals are made to disconnect from each other (block B120), the window control section 14 updates the V window location information 17 stored in the window location information storage section 16 based on the data regarding the setting of the video window, and closes the video window (block B121), thereby ending the communication between the telephone terminals (block B122).

After the communication ends (blocks B122 and B133), when the user selects ending of the VSC client program, the user's VC client logs out from the VC server 1 (block B141), thereby ending the VSC client program (block B142).

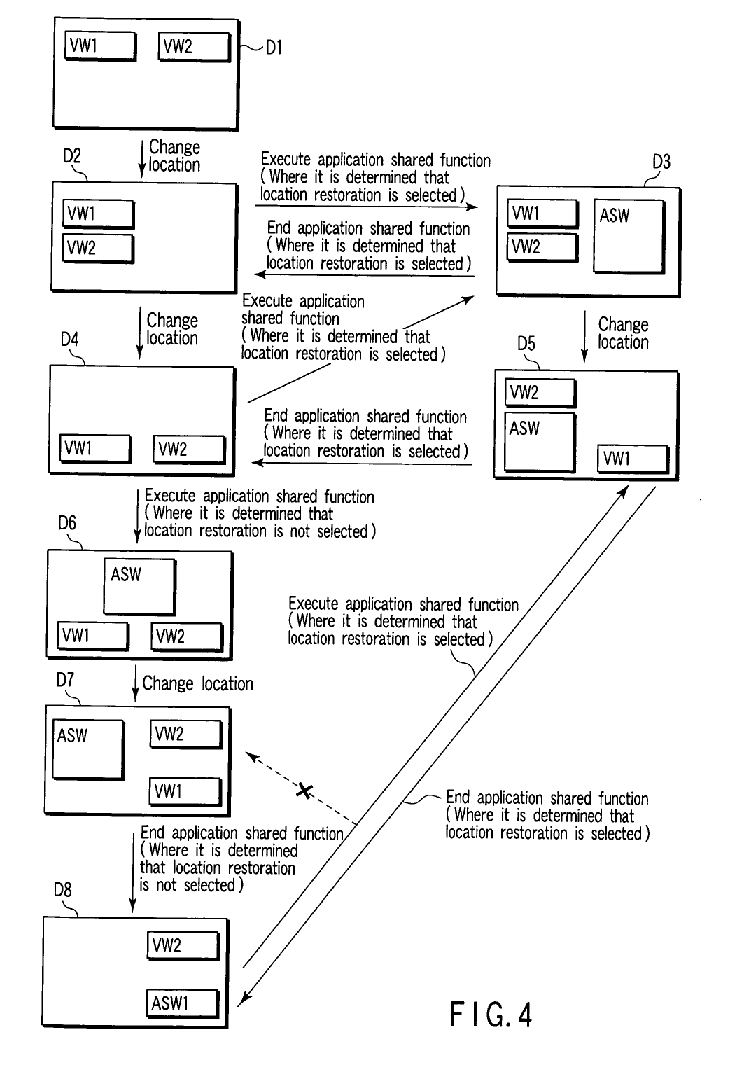

An example of a window control based on the above flowchart will be explained with reference to FIG. 4.

As shown in FIG. 4, in a display image D1, video windows VW1 and VW2 are displayed. Then, in a display image D2, the locations of the video windows VW1 and VW2 are changed from those in the display image D1 by a user's operation. When the application shared function is performed, with the setting for restoring the window location selected, the display image is changed to a display image D3 in which the locations of the video windows VW1 and VW2 are changed from those of the display image D2, and the application shared frame window ASW is displayed. When the application shared function ends, as shown as the display image D2, the application shared frame window ASW closes, and the video windows VW1 and VW2 are relocated in accordance with the setting.

Then, in a display image D4, the locations of the video windows VW1 and VW2 are changed from those in the display image D2. When the application shared function is performed, as shown as the display image D3, the locations of the video windows VW1 and VW2 are changed from those in the display image D4, and the display shared frame window ASW is displayed. Then, a display image D5 is displayed in which the locations of the application shared frame window ASW and the video windows VW1 and VW2 are changed from those in the display image D3. When the display image D5 is displayed, and then when the application shared function ends, as shown as the display image D4, the application shared frame window ASW closes, and the video windows VW1 and VW2 are relocated in accordance with the setting.

Next, the setting is changed to setting in which the window location is not restored. The application shared function is performed, with the display image D4 displayed. Then, a display image D6 is displayed in which the locations of the video windows VW1 and VW2 remain unchanged, and the application shared frame window ASW is displayed.

Subsequently, a display image D7 is displayed in which the locations of the video windows VW1 and VW2 and the application shared window ASW are changed from those in the display image D6. Then, when the application shared function is stopped, a display image D8 is displayed in which the application shared frame window ASW is closed, and the locations of the video windows VW1 and VW2 remain unchanged.

Next, after the setting is changed to the setting for restoring the window location, the application shared function is performed. Then, as shown as the display image D5, the locations of the video windows VW1 and VW2 are changed, and the application shared frame window ASW is displayed. The display image D5 is a display image which is used in the setting for restoring the window location, and which is displayed when the application shared function is stopped.

The above embodiment offers the following convenience to users: a display setting during performing of the video communication only and that during performing of the application shared function are separately managed in the apparatus, and ordinarily, data regarding those display settings is stored/read/restored before and after performing the video communication and the application shared function, thereby enabling the video communication and the application shared function to be performed, with the locations of the windows unchanged from those when the user used the video communication and the application shared function the last time.

Furthermore, in the embodiment, the following options are provided: whether or not to use the display setting for the application shared function can be selected by the user at the time of starting to perform the application shared function; and whether or not to store data regarding the present setting as that regarding setting for the application shared function can be selected by the user at the time of ending the application shared function. Accordingly, the application shared function can be performed, with the locations of the windows in the video communication remaining unchanged, and the video communication can be continued, with the display setting at the time of ending the application shared function remaining unchanged.

According to the specification of the apparatus according to the above embodiment, the display setting of the video window is necessarily automatically stored as data, and whether the display setting at the time of starting to perform the application shared function can be stored or restored can be selected by the user. Further, when the function is enhanced, the following specification can be achieved:

1) The information regarding the location of the video window is not stored, and the window is displayed in a regular manner whenever it is displayed.

2) A window or windows to be located are specified individually.

3) The location of the window or windows to be located is changed to an optimal location thereof in accordance with a standard setting, setting stored as data, and the size of the display area of a screen, etc.

4) A number of location information is provided for each user, thus enabling each user to select a desired location of the window or desired locations of the windows.

Furthermore, the above window control may be performed at a timing different from that in the above explanation. That is, during driving of an application, when another application is driven, the window control may be performed. Alternatively, during driving of a number of applications, when one of them ends, the window control may be performed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display control method of software having a plurality of operation modes, the display control method comprising:
switching a set operation mode to another operation mode;
reading window location information associated with the another operation mode, from a plurality of window location information respectively prepared for the plurality of operation modes; and
displaying a window on a display screen in accordance with the read window location information to switch the set operation mode.

2. The display control method according to claim 1, further comprising,
updating window information associated with the set operation mode based on data regarding setting of the window which is used in switching the set operation mode to said another operation mode.

3. The display control method according to claim 1, wherein the software each executed by a first information processing apparatus including the display screen and a first camera, and second first information processing apparatus including a another display screen and a second camera, and
a first window displaying a picture taken by the first camera and a second window displaying a picture taken by the second camera displayed on the display screen includes.

4. The display control method according to claim 3, wherein the display screen further includes a third window which is a application window which is displayed on the another display screen.

5. The display control method according to claim 4, wherein the operation modes includes
a first operation mode for displaying the first window, and the second window on the display screen, and
a second operation mode for displaying the first window, the second window and third window on the display screen.

6. An information processing apparatus having a plurality of operation modes, comprising:
a switching unit which switches a set operation mode to another operation mode;
a location information storage unit which stores a plurality of window location information respectively associated with the plurality of operation modes; and
a window control unit which reads window location information associated with said another operation mode, when the set operation mode is switched to said another operation mode by the switching unit, and causes a window to be displayed on a display screen in accordance with the read window location information.

7. The information processing apparatus according to claim 6, wherein the window control unit updates window location information associated with the set operation mode which is stored as data in the location information storage unit, by using data regarding setting of the window which is used in switching the set operation mode to said another operation mode.

8. The information processing apparatus according to claim 6, further comprising a first camera, wherein a first window displaying a picture taken by the first camera and a second window displaying a picture taken by a another camera which the another information processing apparatus displayed on the display screen.

9. The display control method according to claim 8, wherein a third window which is a application window which is displayed on a another display screen which the another information processing apparatus includes.

10. The information processing apparatus according to claim 9, wherein the operation modes includes
a first operation mode for displaying the first window, and the second window on the display screen, and
a second operation mode for displaying the first window, the second window and third window on the display screen.
